(19) United States
(12) Patent Application Publication
(10) Pub. No.: US 2025/0079524 A1
(43) Pub. Date: Mar. 6, 2025

(54) BATTERY CELL HAVING NON-SOLVATING ELECTROLYTES

(71) Applicant: Apple Inc., Cupertino, CA (US)

(72) Inventors: Andrew Basile, Santa Clara, CA (US); Alan A. Ritchie, Menlo Park, CA (US)

(21) Appl. No.: 18/819,348

(22) Filed: Aug. 29, 2024

Related U.S. Application Data
(60) Provisional application No. 63/580,251, filed on Sep. 1, 2023.

(51) Int. Cl. H01M 10/0568; H01M 10/0525; H01M 10/0567; H01M 10/0569; H01M 50/411; H01M 50/449; H01M 50/46; H01M 50/491

(52) U.S. Cl. CPC H01M 10/0568; H01M 10/0525; H01M 10/0567; H01M 10/0569; H01M 50/411; H01M 50/449; H01M 50/461; H01M 50/491

(57) ABSTRACT

This disclosure relates generally to battery cells, and more particularly, liquid electrolyte solvents, diluents, and designs for lithium-ion battery cells.

### PRIORITY

This patent application claims the benefit of U.S. Provisional Patent Application No. 63/580,251, entitled “ELECTROLYTE WITH NON-SOLVATING LIQUID FOR CATHODE STABILITY,” filed on Sep. 1, 2023, which is incorporated herein by reference in its entirety.

### FIELD

This disclosure relates generally to battery cells, and more particularly, electrolytes for use in lithium ion battery cells.

### BACKGROUND

Li-ion batteries are widely used as the power sources in consumer electronics. Consumer electronics need Li-ion batteries which can deliver higher volumetric energy densities and sustain more discharge-charge cycles. A Li-ion battery typically works at a voltage up to 4.45 V (full cell voltage).

A battery life cycle can deteriorate due to degradation of the cathode active material and anode active material by liquid electrolyte. Limited progress has been made in developing liquid electrolytes that simultaneously maintain the integrity of both the cathode active material and anode active material.

### SUMMARY

In a first aspect, the disclosure is directed to a liquid electrolyte comprising bis(2,2,2-trifluoroethyl)carbonate (TFEC) diluent and bis(1,1-difluoroethoxy)ethane (BDOE) solvent. In some variations, the ratio of wt % TFEC diluent to wt % BDOE solvent can be 1:5.0-1:2.0. In some variations, the liquid electrolyte includes a lithium salt selected from LiFSI, LiTFSI, LiBOB, LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof. In further variations, the lithium salt is LiFSI, or a combination of LiFSI and LiBOB. In some additional variations, the lithium salt is in an amount of 15-50 mol % of the liquid electrolyte. In further variations, the liquid electrolyte includes an additive selected from lithium N-methyl-N-propylpyrrolidinium bis(fluorosulfonyl)imide, difluoro(oxalato)borate (LiDFOB), pro-1-ene-1,3-sultone (PES), methylene methanedisulfonate (MMDS), propylene carbonate (PC), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), and a combination thereof. In some variations, the ionic liquid N-methyl-N-propylpyrrolidinium bis(fluorosulfonyl)imide is added. Each of the additives above can be individually chosen or selected from amongst the listed additives.

In a second aspect, the disclosure is directed to a battery cell having a cathode including a cathode active material disposed on a cathode current collector and an anode including an anode active material disposed on an anode current collector. The anode is oriented towards the cathode such that the anode active material faces the cathode active material. A separator disposed between the cathode active material and the anode active material. The liquid electrolyte is disposed between the cathode and anode.

In some variations, the battery cell includes a polymer composite layer disposed between the anode and separator. In further variations, an anode cap layer is disposed between the anode and polymer composite layer. In some still further variations, one or more metals of the anode cap layer are Sn and Cu. The polymer composite layer can adhere the anode cap layer to the separator.

The polymer composite layer can include a crosslinked polymer backbone, polyethylene glycol, polycaprolactone, and a lithium salt. The crosslinked polymer backbone has an un-crosslinked molecular weight of between 100,000 g/mol and 2,000,000 g/mol and is selected from the group consisting of PVDF-HFP, PEGDMA, polyDDA, PVB, PUA, PEO, PAN, PMMA, and copolymers thereof. The polyethylene glycol can have a molecular weight between 20,000 g/mol and 200,000 g/mol and can be between 1.0 wt % and 20.0 wt % of the polymer composite layer. The polycaprolactone can have a molecular weight between 20,000 g/mol and 200,000 g/mol and can be between 1.0 wt % and 40.0 wt % of the polymer composite layer. In some variations, the polymer composite layer has a porosity of less than 10.0%.

In some additional variations, the ratio of the lithium salt to a total of the cross linked polymer backbone, the polyethylene glycol, and the polycaprolactone is less than 0.4:1.0. In further lithium metal battery has an external operating pressure of 20 psi or less. In still further variations, the crosslinked polymer backbone is PVDF-HFP.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell in accordance with an illustrative embodiment; and

FIG. 2 is a perspective view of a battery cell in accordance with an illustrative embodiment;

FIG. 3 is a perspective view of a battery cell in accordance with an illustrative embodiment;

FIG. 4 is a perspective view of a battery cell in accordance with an illustrative embodiment;

FIG. 5 depicts a cartoon of the components of the liquid electrolyte including an inner solvation shell 502 outer screening shell 504, according to an illustrative embodiment;

FIGS. 6A and 6B are Nyquist plots depicting the impedance of a battery cell having a liquid electrolyte with or without FEC co-solvent or BTFE diluent, according to illustrative embodiments;

FIG. 7A, 7B, and 7C depict Nyquist plots containing TFEC diluent, TTE diluent, and BTFE diluent, according to illustrative embodiments; and

FIG. 8A depicts the capacity as a function of cycle number, and resistance of as a function of cycle number for battery cells with a liquid electrolyte containing TFEC diluent and BDOE solvent with and without an SnCu cap and/or polymer composite layer (PE layer), according to illustrative embodiments; and

FIG. 8B shows the energy and ratio as a function of cycle number, according to illustrative embodiments.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The disclosure is directed to an electrolyte providing low voltage stability at the anode in the presence of reactive lithium metal, and high voltage stability at the cathode. The liquid electrolyte includes the solvent BDOE to provide anode stability and the diluent TFEC to provide cathode stability. The battery cell further provides a anode cap layer disposed on the surface of the anode, and a polymer composite layer disposed on the anode cap layer. The liquid electrolyte including the solvent and non-solvating diluent liquid prepared satisfy the stability requirements for each electrode of a lithium ion battery.

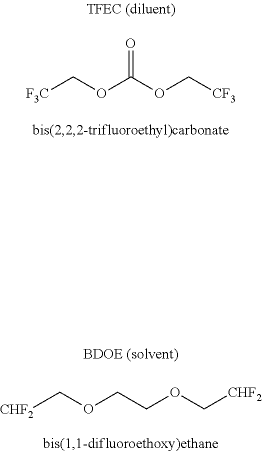 [SMILES: O=C(OCC(F)(F)F)OCC(F)(F)F ; FC(F)COCCOCC(F)F]

### Battery Cells

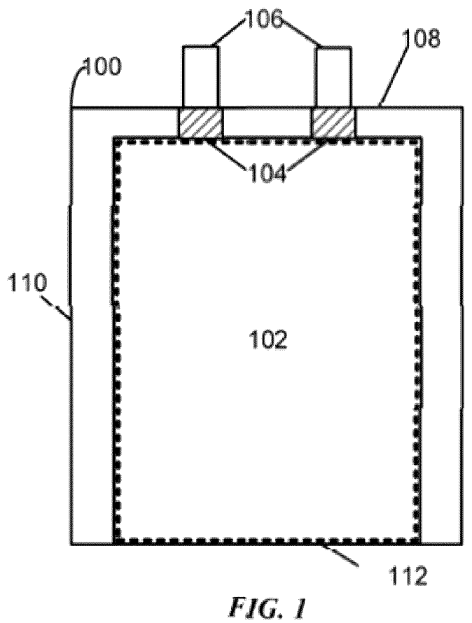

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode with a cathode active coating, a separator, and an anode with an anode active coating. More specifically, the stack 102 may include one strip of cathode active material (e.g., aluminum foil coated with a lithium compound) and one strip of anode active material (e.g., copper foil coated with carbon). The stack 102 also includes one strip of separator material (e.g., a microporous polymer membrane or non-woven fabric mat) disposed between the one strip of cathode active material and the one strip of anode active material. The cathode, anode, and separator layers may be left flat in a planar configuration or may be wrapped into a wound configuration (e.g., a “jelly roll”). An electrolyte solution is disposed between each cathode and anode.

During assembly of the battery cell 100, the stack 102 can be enclosed in a pouch or container. The stack 102 may be in a planar or wound configuration, although other configurations are possible. In some variations, the pouch such as a pouch formed by folding a flexible sheet along a fold line 112. In some instances, the flexible sheet is made of aluminum with a polymer film, such as polypropylene. After the flexible sheet is folded, the flexible sheet can be sealed, for example, by applying heat along a side seal 110 and along a terrace seal 108. The flexible pouch may be less than or equal to 120 microns thick to improve the packaging efficiency of the battery cell 100, the density of battery cell 100, or both.

The stack 102 can also include a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

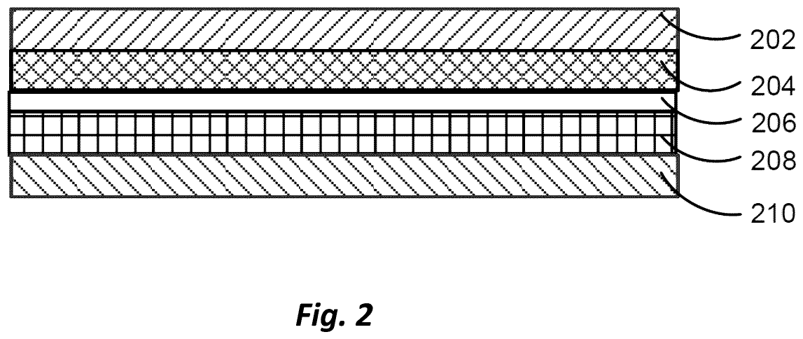

FIG. 2 presents a perspective view of battery cell 200 (e.g., the battery cell 100 of FIG. 1) in accordance with the disclosed embodiments. The battery includes a cathode 202 that includes current collector 204 and cathode active material 206 and anode 210 including anode current collector 212 and anode active material 214. Separator 208 is disposed between cathode 202 and anode 210. Liquid electrolyte 216 is disposed between cathode 202 and anode 210, and is in contact with separator 208. To create the battery cell, cathode 202, separator 208, and anode 210 may be stacked in a planar configuration, or stacked and then wrapped into a wound configuration. Liquid electrolyte 216 can then be added. Before assembly of the battery cell, the set of layers may correspond to a cell stack.

The cathode current collector, cathode active material, anode current collector, anode active material, and separator may be any material known in the art. In some variations, the cathode current collector may be an aluminum foil, the anode current collector may be a copper foil. The cathode active material can be any material described in, for example, Ser. No. 14/206,654, Ser. No. 15/458,604, Ser. No. 15/458,612, Ser. No. 15/709,961, Ser. No. 15/710,540, Ser. No. 15/804,186, Ser. No. 16/531,883, Ser. No. 16/529,545, Ser. No. 16/999,307, Ser. No. 16/999,328, Ser. No. 16/999,265, each of which is incorporated herein by reference in its entirety.

A salt, solvent, and non-solvating diluent liquid prepared into liquid electrolyte formulation can simultaneously satisfy stability requirements for each electrode of a lithium metal battery design.

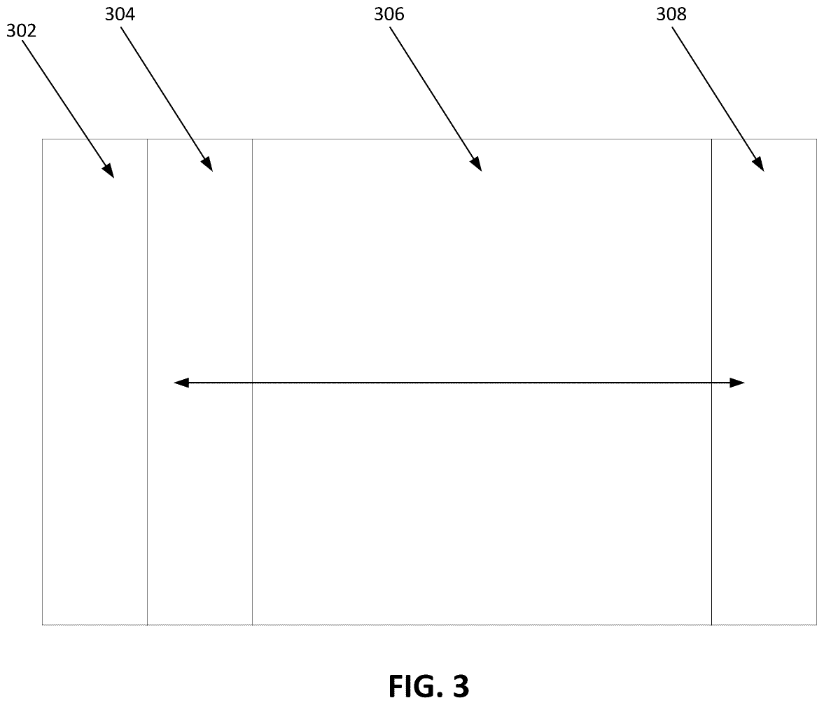

FIG. 3 depicts a battery cell 300 comprising lithium anode 302, a polymer composite layer 304, a porous inert separator 306, and cathode 308. The polymer composite layer 304 is salt and solvent permeable, but not diluent permeable. The polymer composite layer substantially limits accessibility of the TFEC diluent at the anode, while allowing access to the salt, solvent, lithium, anion, and additives to reach the anode. The TFEC diluentis prevented or limited from reaching the anode surface, and therefore eliminates and/or prevents anode active material.

The ratio of wt % TFEC diluent to wt % BDOE solvent can be from 1:5.0-1:2.0. The ratio can have a minimum and/or maximum. In some variations, the ratio of wt % TFEC to wt % BDOE is at least 1:5.0. In some variations, the ratio of wt % TFEC to wt % BDOE is at least 1:4.5. In some variations, the ratio of wt % TFEC to wt % BDOE is at least 1:4.0. In some variations, the ratio of wt % TFEC to wt % BDOE is at least 1:3.5. In some variations, the ratio of wt % TFEC to wt % BDOE is at least 1:3.0. In some variations, the ratio of wt % TFEC to wt % BDOE is at least 1:2.5. In some variations, the ratio of wt % TFEC to wt % BDOE is less than or equal to 1:2.0. In some variations, the ratio of wt % TFEC to wt % BDOE is less than or equal to 1:2.5. In some variations, the ratio of wt % TFEC to wt % BDOE is less than or equal to 1:3.0. In some variations, the ratio of wt % TFEC to wt % BDOE is less than or equal to 1:3.5. In some variations, the ratio of wt % TFEC to wt % BDOE is less than or equal to 1:4.0. In some variations, the ratio of wt % TFEC to wt % BDOE is less than or equal to 1:4.5. Any upper amount can be combined with any lower amount in any combination, as described herein.

The separator may include a microporous polymer membrane or non-woven fabric mat. Non-limiting examples of the microporous polymer membrane or non-woven fabric mat include microporous polymer membranes or non-woven fabric mats of polyethylene (PE), polypropylene (PP), polyamide (PA), polytetrafluoroethylene (PTFE), polyvinyl chloride (PVC), polyester, and polyvinylidene difluoride (PVdF). However, other microporous polymer membranes or non-woven fabric mats are possible (e.g., gel polymer electrolytes).

In general, separators represent structures in a battery, such as interposed layers, that prevent physical contact of cathodes and anodes while allowing ions to transport therebetween. Separators are formed of materials having pores that provide channels for ion transport, which may include absorbing a liquid electrolyte that contains the ions. Materials for separators may be selected according to chemical stability, porosity, pore size, permeability, wettability, mechanical strength, dimensional stability, softening temperature, and thermal shrinkage. These parameters can influence battery performance and safety during operation.

In general, liquid electrolyte can act a conductive pathway for the movement of cations passing from the negative to the positive electrodes during discharge. The liquid electrolyte includes an electrolyte salt, electrolyte solvent, and one or more electrolyte additives.

### Polymer Composite Layer and Anode Cap

The polymer composite layer as described herein is disclosed, for example, in U.S. patent application Ser. No. 18/226,813, which is incorporated by reference herein in its entirety.

The polymer composite layers disclosed herein have improved pore control, ion conductivity, and separator bond strength when compared to known protective layers. The polymer composite layers disclosed herein have low stiffness, moderate tensile strength and sufficient elongation, providing the requisite mechanical strength, e.g., the ability to bend without breaking and the ability to absorb impact energy

The electrochemical cells disclosed herein achieve the high volumetric and gravimetric energy densities with a well bonded stack of layers including an anode current collector, a lithium metal anode, an anode cap layer, a polymer composite layer and a separator. The specific layer sequence of lithium metal, in the form of a lithium metal anode capped with the anode cap layer and protected from the liquid electrolyte by the polymer composite layer, enables dense and uniform lithium plating between the anode current collector and the anode cap layer, creating a liquid electrolyte-free, chemically protected environment during cell cycling. The specific layers and the sequence of the layers avoid low density lithium plating, thereby enabling and retaining high volumetric energy density in conjunction with long cycle life, all without the need for an external pressure fixture.

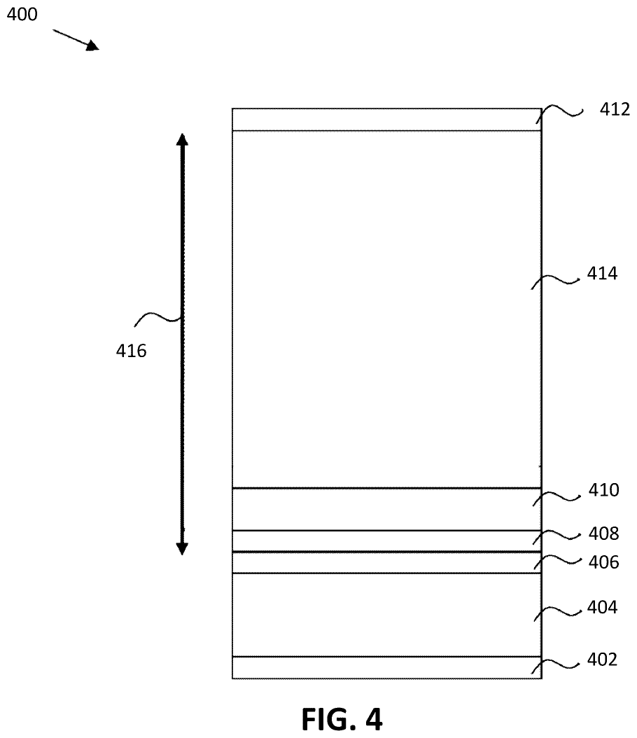

With respect to FIG. 4, the electrochemical cells 400 disclosed herein provide solutions to the problems discussed herein by using a spatially separated, and thus chemically separated, lithium metal anode from the liquid electrolyte via interposing the combination of the anode cap layer 406 and the polymer composite layer 408, with the anode cap layer 406 in direct contact with the lithium metal anode 404 and the polymer composite layer 408 in direct contact with the liquid electrolyte 416, as illustrated in FIG. 1. The polymer composite layer 408 takes up lithium salt and solvent molecules from the liquid electrolyte 416 during cycling to convert the as-fabricated polymer composite layer 408 to a polymer electrolyte layer while limiting the interaction between the lithium metal anode 404 and the solvent and promoting a uniform interface at the anode cap layer 406. The electrochemical cells 400 disclosed herein provide low impedance and uniform, bonded interfaces. These bonded interfaces avoid pooling of liquid electrolyte at the interface with the lithium metal anode, preventing the uncontrolled growth of low density, high volume, dendritic, fluffy lithium metal morphology into the liquid electrolyte space.

The anode cap layer 406 includes one or more metals, at least one of the one or more metals alloyed with the lithium metal of the anode 404. In various aspects, the anode cap layer 406 can be from 0.01 μm to 10 μm in thickness, and in particular from 0.2 μm to 3.0 μm, and is composed of the maximally lithiated alloy of a given metal M that is capable of fomling an inter-metallic compound with lithium. M may comprise one or more metal elements (ternary, quaternary, quinary, etc.) and may be selected from Sn, Sb, Si, Au, Zn, Al, and Mg, as non-limiting examples. M may also contain elements which, if binary, would only form solid solutions with lithium, such as Cu, Ti, and Ni.

LiSn is a non-limiting example of the anode cap layer. A galvanic cell is formed when lithium and tin are in contact, which drives alloy formation to a stable situation at low temperatures. LiSn also diffuses lithium ions very quickly. LiSn has a diffusion coefficient of about 10−7 cm²/s, while LiPON and LiCoO2 have diffusion coefficients of 10−9 cm²/s and 10−10 cm²/s. Lithium and tin are both active materials. Adding an inactive matrix such as Cu, Ti, Ni, or Ni Ti can provide further stability as these components will not react or move within the layer. Non-limiting examples of the anode cap layer include LiSnCu, LiSnTi, LiSnNi, and LiSnNiTi. These layer compositions may be formulated such that, for example, the LiSnCu layer may be Cu rich, or the LiSnCu layer may be coated with a Cu skin near the polymer composite layer 408. By the same token, the LiSnNiTi layer, for example, may be Ni or Ti rich, or may be coated with a Ni, Ti, or NiTi skin near the polymer composite layer 408.

The anode cap layer is in contact with an excess amount of lithium metal, in the form of the lithium metal anode, and thus adopts the maximally lithiated alloy possible for M during a given cell's life. Empirically, it was found that upon cell charge the lithium atoms plate densely and uniformly between the anode cap layer 406 and the existing lithium metal at very low impedance while fusing with the latter. This location of lithium plating is desired. A reason that the lithium atoms prefer to plate between the anode cap layer and the lithium metal anode, rather than the anode cap layer and the polymer composite layer, is rooted in a thermodynamic voltage gradient which disappears not until the incoming lithium atoms reach the lithitml metal anode bulk. Upon discharge, the plated lithium is stripped off uniformly. The polymer composite layer can be used in an electrochemical cell without the anode cap layer, with the polymer composite layer laminating the separator to the lithium metal or anode current collector. However, the inventors have found that the anode cap layer enables flatter and denser plating of the lithium metal.

The anode cap layer can be formed from an in-situ reaction layer of, for instance, vapor deposited M onto the lithium metal anode followed by a controlled surface passivation with, for instance, CO₂ gas or mixtures thereof or ex-situ dip solutions containing diluted carboxylic acids in hydrocarbon. Other approaches exist to form the anode cap layer, such as, for instance, (i) dip coating of the lithium metal anode into a solution that contains salt(s) of M with which the lithium metal anode seed reacts to LiₓM or (ii) providing salt(s) of M as additives in the polymer composite layer, wherein the lithium metal anode reacts in-situ at its surface to LixM when the polymer composite layer slurry is applied onto the lithium metal anode.

The polymer composite layer 408 has a crosslinked polymer backbone, polyethylene glycol (PEG), polycaprolactone (PCL), and at least one lithium salt. These can be the sole components of the polymer composite layer 408 as fabricated. It is contemplated that additional components may be included but are not necessary. It is noted that during cell charge and discharge, the polymer composite layer may take up lithium salt and a finite amount of solvent from the liquid electrolyte 416, while limiting the interaction between the anode and the solvent and promoting a uniform interface at the anode cap layer 406. With the exception of the casting solvent, which is evaporated from and does not remain in the as fabricated polymer composite layer, no ionic liquid or other solvents are used or remain in the as fabricated polymer composite layer. The polymer composite layer 408 can be between about 0.01 μm and 5.0 μm in thickness, and more particularly, from about 1.5 μm to 3.0 μm in thickness.

The crosslinked polymer backbone is a cross-linked polymer having an un-crosslinked molecular weight of between 100,000 g/mol and 2,000,000 g/mol and is between 40.0 wt % and 90.0 wt % of the as-fabricated polymer composite layer 408. All ranges herein are inclusive. The polymer backbone is a polymer that is stable with lithium metal and the metals of the anode cap layer and is resilient to dissolution in the liquid electrolyte 416 with minimal swelling. The polymer backbone provides a structural matrix to host the PEG and PCL and provides the bonding (lamination) between the separator and anode. The polymer of the polymer backbone can be poly(vinylidene fluoride)-co-hexafluoropropylene (PVDF-HFP), poly(vinylidene fluoride) (PVDF), polyethylene glycol dimethacrylate (PEGDMA), polydiallyldimethylammonium bis(fluorosulfonyl)imide (polyDDA FSI), polyvinyl butyral (PVB), poly(urethane acrylate) (PUA), polyethylene glycol (PEO), polyacrylonitrile (PAN), poly(methyl methacrylate) (PMMA), or a copolymer thereof. The crosslinked polymer backbone can be one polymer or can be a mixture of more than one polymer. The polymer backbones can be in a fully or partially crosslinked form, and the crosslinking within the backbone can be achieved by both chemical crosslinking (during synthesis) and physical crosslinking (such as the dissociated lithium salt coordination with the polymer's fluorine atoms).

The PEG has a molecular weight between 20,000 g/mol and 200,000 g/mol and is between 1.0 wi % and 20.0 wi: % of the as fabricated polymer composite layer 408. The PCL has a molecular weight between 20,000 g/mol and 200,000 g/mol and is between 1.0 wt % and 40.0 wt % of the as fabricated polymer composite layer 408. Both the PEG and the PCL can be linear or branched with 3, 4, 6 or 8 arms. The molecular weight range provides a suitable window to enable the PEG and PCL to plasticize in the presence of the liquid electrolyte 416 but not dissolve. The ratio of PCL to PEG in the polymer composite layer is 1:1 to 3:1. The addition of PEG and PCL creates free volume for the lithium salt and a finite amount of solvent from the liquid electrolyte, enables lithium salt dissociation and lithium ion conductivity, provides added structural support to the polymer composite layer, and provides additional bonding to the anode and separator.

### Lithium Salts

The lithium salt can be any lithium salt known in the art. The lithium salt can be one or more than one of lithium bis(fluorosulfonyl)imide (LiFSI), lithium bis(trifluoromethanesulfonyl)imide (LiTFSI), lithium bis(oxalato)-borate (LiBOB), lithium hexafluorophosphate (LiPF₆), lithium tetrafluoroborate (LiBF₄), lithium perchlorate (LiClO₄), LiSO₃CF₃, LiN(SO₂F)₂, LiN(SO₂CF₃)₂, LiBC₄O₈, Li[PF₃(C₂CF₅)₃], and LiC(SO₂CF₃)₃, as non-limiting examples. As a further non-limiting example, a dual salt system can be used, such as LiFSI and LiBOB. The addition of the lithium salt(s) to the polymer composite layer 408 can improve ionic conductivity and low temperature performance. LiBOB, can passivate the aluminum cathode current collector to suppress SFI-Al corrosion.

In various aspects, the lithium salt can be 15-50 mol % in the liquid electrolyte. The salt can have a mol % of a lower limit and/or an upper limit, in any combination described herein. In some variations, the lithium salt can be at least 15 mol % of the liquid electrolyte. In some variations, the lithium salt can be at least 20 mol % of the liquid electrolyte. In some variations, the lithium salt can be at least 25 mol % of the liquid electrolyte. In some variations, the lithium salt can be at least 30 mol % of the liquid electrolyte. In some variations, the lithium salt can be at least 35 mol % of the liquid electrolyte. In some variations, the lithium salt can be at least 40 mol % of the liquid electrolyte. In some variations, the lithium salt can be at least 45 mol % of the liquid electrolyte. In some variations, the lithium salt can be less than or equal to 50 mol % of the liquid electrolyte. In some variations, the lithium salt can be less than or equal to 45 mol % of the liquid electrolyte. In some variations, the lithium salt can be less than or equal to 40 mol % of the liquid electrolyte. In some variations, the lithium salt can be less than or equal to 35 mol % of the liquid electrolyte. In some variations, the lithium salt can be less than or equal to 30 mol % of the liquid electrolyte. In some variations, the lithium salt can be less than or equal to 25 mol % of the liquid electrolyte. In some variations, the lithium salt can be less than or equal to 20 mol % of the liquid electrolyte.

The lithium salt is necessary for ion conduction. However, known polymer electrolytes may depend solely on the salt for ion conduction and are gated by the need for large amounts of the lithium salt and its inherent pore forming action. The higher porosity (20% or greater) and larger pores (maximum pore diameters of 2 μm or greater) in a polymer electrolyte film are undesirable as liquid electrolyte is pem litted to react with the underlying lithium metal anode. The mechanism which creates the large pores was the use of high concentrations of salt and a casting solvent. During the film processing, the solvent evaporates, leaving behind pores filled with salt. To resolve this, additional means of lithium ion conduction was sought, independent of the lithium salt.

The addition of PEG enhances the ion conductivity in the polymer composite layer 408. However, the use of PEG alone provides a dense polymer film with no visible pores. FIG. 2 is an SEM/EDS image of the surface of a polymer backbone (PVDF-HFP used here) with 40,000 g/mol molecular weight 8 arm PEG, showing no visible pores. The ion conductivity is not sufficient without some introduction of lithium salt, and the lack of porosity only enables very small amounts (less than 5.0 wt %) of lithium salt to be added before non-uniform, undesirable porosity occurs.

PCL produces a pore forming property when combined with the polymer backbone. PCL forms smaller (less than or equal to 1.0 μm maximum diameter), more uniform pores than that that occurs when forming pores with the addition of lithium salt. FIG. 3 is an SEM/EDS image of the surface of a polymer backbone (PVDF-HFP used here) with 80,000 g/mol molecular weight PCL, showing small, unifom1 pores. Blending the PCL and PEG results in small, unifom1 pores filled with PEG, which is ion conductive. With PCL as the pore former and PEG as the pore filler, varying the ratio of PEG and PCL within the polymer composite layer enables the tuning of the porosity of the polymer composite layer. The desired porosity is sufficient to provide the requisite ion conductivity but as low as possible to limit the pooling of the liquid electrolyte solvent. The polymer composite layer 408 disclosed herein has a porosity of between 1.0 wt % and 10.0 wt %, more particularly, between 1.0 wt % and 8.0 wt %, and more particularly, between 1.0 wt % and 5.0 wt %.

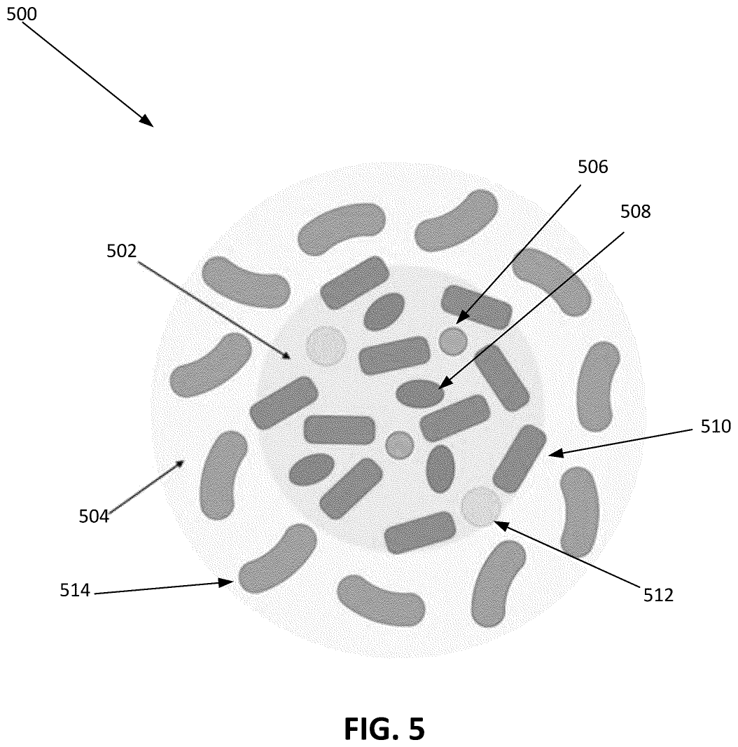

With the use of PEG for ion conductivity, the amount of lithium salt required to achieve the overall ion conductivity in the polymer composite layer can be reduced. For example, the ratio of lithium salt to the total of the crosslinked polymer backbone, PEG, and PCL is less than 0.4:1.0, and more particularly 0.2:1, compared to ratios of 1.1:1.0 of lithium salt to polymer in knm, vn polymer electrolyte layers. FIGS. 4 and 5 are SEM/EDS images illustrating the impact of increased lithium salt concentration of the pore size and uniformity. FIGS. 4 and 5 are images of the surfaces of polymer composite layers prior to bonding with the separator. The polymer composite layer has 20 wt % total of PEG and PCL and 80 wt % of PVDF-HFP and the ratio of PCL to PEG is 3:1. In some variations, the lithium salt is 17.0 wt % of the polymer composite layer, resulting in 8.0% porosity, while in other variations, the lithium salt is 34.0 wt % of the polymer composite layer, resulting in 19.0% porosity. With both PEG and lithium salt contributing to the ion conductivity, the lower concentrations of lithium salt achieve a polymer composite layer 408 with an ion conductivity of greater than or equal to 0.6×10−4 S/cm⁻¹. The polymer composite layer acts as a protective layer to block contact between the liquid electrolyte and the lithium metal anode, reducing or preventing the continuous reaction between the electrolyte and the lithium metal. The polymer composite layer serves as an additional electrolyte layer as the polymer composite layer is lithium ion conductive, promoting uniform lithium distribution and plating at the electrode interface.

The combination of the PEG and the PCL have other synergistic effects. PEG is more polar than PCL, allowing the polarity of the polymer composite layer to be tuned by varying the ratio of PEG to PCL.

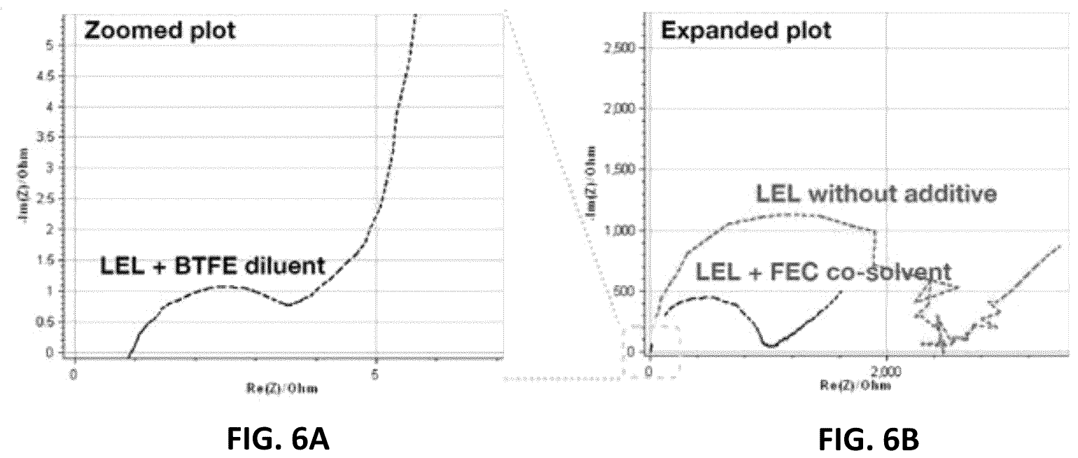

PCL does not form a separate melting peak/crystalline phase, integrating will with the polymer backbone and lithium salt system. PEG forms separate crystalline phases as its polarity is significantly different from the polymer backbone. Blending PEG and PCL reduces the crystallinity of PEG, enhancing the polymer chain mobility and improving the room temperature conductivity of the polymer composite layer. See the graph in FIG. 6, illustrating the crystallinity of PEGs, PCL, a mixture of PEG and PCL, and no PEG or PCL. The higher the enthalpy of fusion, the greater the degree of crystallinity. Crystallinity makes a material strong, but also makes it brittle. The polymer composite layers disclosed herein have the ability to bend without breaking and to absorb impact energy.

Blending of PEG and PCL lowers the stiffness, provides moderate tensile strength and longer elongation, and renders the polymer composite layer highly elastomeric. When a material has a higher stiffness, it is harder and has less adhesion. It also has no flexibility to adapt to the lithitm 1 surface roughness. The polymer composite layers disclosed herein have lower stiffness, moderate tensile strength and longer elongation, providing an excellent bonding material to adhere the separator to the anode.

The polymer composite layer serves to laminate, or bond, the anode, whether it's the anode cap layer or lithium metal, to the separator, providing strong adhesion between the layers. The internal pressure provided by the bond onto the lithium metal facilitates dense lithium plating at low or no external pressure. The combination of the polymer backbone, PEG, and PCL provide excellent bond strength between the anode and separator, exceeding 60 N/m peel strength, and even reaching 70 N/m peel strength using a 7 day LE soak test of the anode, polymer composite layer, and separator. To achieve this strong bonding, the polymer composite layer slurry is cast onto the anode cap layer (or lithium metal of the anode if no cap layer) before the separator is laid into the slurry before the slurry is dry. The created bond strength is a function of the polymer composite layer, the casting solvent, and the post-cast drying conditions. The casting solvent can be dimethylacetamide (DMAc), dimethylformamide (DMF), N-methyl-2-pyrrolidone (NMP), tetramethylurea (TMU), N,N-diethylacetamide (DEAc), triethyl phosphate (TEP) and mixtures thereof. The casting solvent is not part of the as fabricated polymer composite layer or electrochemical cell.

The combination of the strong bonding of the separator to the anode and the reduced porosity of the polymer composite layer enables the use of a separator with increased porosity. Separators with a porosity of 60% or greater can be used, compared to a conventional 40% or less separator porosity, which reduces internal cell resistance. The increased separator porosity also improves the elastic behavior of the separator and the layers to which it is bonded, which better accomodates lithium plating non-uniformities.

The polymer composite layer 408 disclosed herein reduces the non-uniform and fluffy lithium plating while lowering or eliminating external operating pressure requirements on the battery, resulting in stable cell perfornlance. The electrochemical cell stack design with the polymer composite layer bonding the separator to the anode allows cycling at O psi external operating pressure and C/3 charge rate. Upwards of 240 cycles are realized at greater than 80% discharge capacity, a 60% improvement over conventional lithitm1 battery cell designs.

Two embodiments of the polymer composite layers 408 as fabricated disclosed herein are provided in the table below.

| | Embodiment 1 | Embodiment 2 |
|---|---|---|
| PVDF-HFP wt % | 62.25 | 56.25 |
| PCL wt % | 14.37 | 12.98 |
| PEG wt % | 6.38 | 5.77 |
| LiFSI wt % | 13.79 | 20.28 |
| LiBOB wt % | 3.21 | 4.73 |
| Total lithium salt wt % | 17.0 | 25.01 |
| Ratio of PCL to PEG | 2.25:1 | 2.25:1 |
| Ratio of lithium salt | 0.2:1 | 0.33:1 |
| to total polymer | | |
| Porosity | 8% | 10% |

Without wishing to be limited to any particular theory or mode of action, FIG. 5 depicts a cartoon of the components of the liquid electrolyte. The salt and additive system 500 includes inner solvation shell 502 outer screening shell 504. Inner solvation shell 502 includes lithium ions 506, anion 508, ionic additives 510, and solvent 512. Outer screening shell 504 includes screening diluent 514. During battery cell operation, the outer screening shell 504 including diluent 514 can limit access of access of the TFEC. The inability of the diluent to dissolve salt, it is not participating in the inner solvation shell. The lithium ions 506, anion 508, ionic additives 510, and solvent 512 are not able to access the cathode. The diluent reaches the cathode before the lithium ions of the inner shell. At the cathode end, TFEC provides screening action.

Further, without wishing to be limited to any particular theory or mode of action, the TFEC diluent is in the outer solvation shell/sphere of a dissolved Li-ion in solution. The TFEC diluent occupies outer solvation shell due to weak salt interaction, surrounds salt and solvent components occupying the inner solvation shell (salt and solvent interact strongly). The TFEC diluent molecule can screen the reactivity of the salt and solvent components at the cathode. The TFEC diluent has limited affinity to infiltrate polymer composite layer and remains in cathode facing compartment.

The TFEC diluent can reduce the overall cell impedance when using reactive electrolyte formulations. Impedance can be utilized to describe reduction in reactivity from >1000 Ω to more typical value <5 Ω by imparting diluent screening functionality

FIGS. 6A and 6B are Nyquist plots depicting the impedance of a battery cell having a liquid electrolyte including LiFSI+P13FSI+DMAc with or without FEC co-solvent or BTFE diluent. FIG. 6A is a zoom plot of FIG. 6B.

As depicted in FIG. 6B, the reactivity of the components with lithium, the liquid electrolyte without FEC shows 200 ohms of impedance. However, the impedance of a battery cells containing FEC co-solvent shows screening of the solvent, thereby reducing interaction of the components with the anode or cathode. In the FIG. 6A zoom plot of FIG. 6B, the reactivity of the solvent is substantially reduced upon the addition of BTFE diluent. The diluent shows only a few ohms of interfacial impedance using BTFE diluent. The power of the diluent to screen reactivity for a bare lithium metal. The BTFE diluent provide cathode and anode stability.

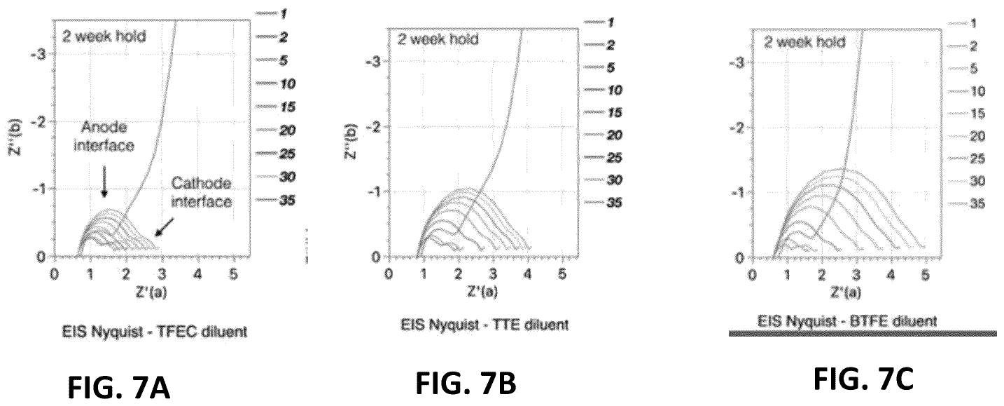

FIG. 7A, 7B, and 7C depict Nyquist plots containing TFEC diluent, TTE diluent, and BTFE diluent. While charging the cell, the impedance on each cell was observed. In the non-charged state, a large tail was observed for each diluent. As depicted in FIG. 7A and the TFEC diluent, the anode interface showed the least amount of growth. As depicted in FIG. 7B, the anode interface grew more than TFEC. As depicted in FIG. 7C, a BTFE diluent showed substantially more anode growth.

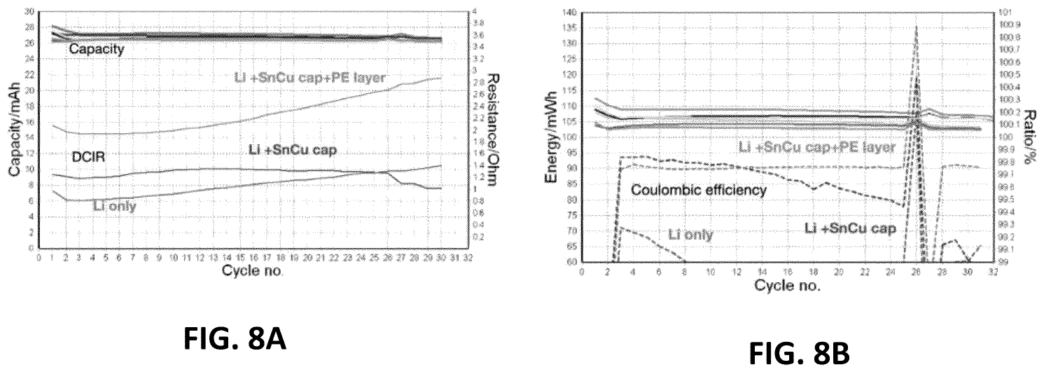

FIG. 8A depicts the capacity as a function of cycle number, and resistance of as a function of cycle number for battery cells with a liquid electrolyte containing TFEC diluent and BDOE solvent with and without an SnCu cap and/or polymer composite layer (PE layer). FIG. 8B shows the energy and ratio as a function of cycle number. The bare lithium anode exposed to the liquid electrolyte containing TFEC shows an instantaneous drop in direct current internal resistance (DCIR) and coulombic efficiency (CE), along with a collapsed anode interface. These data are all indicative of a failing anode. The introduction of a LiCuSn cap layer delayed the onset of anode failure, however by cycle 12 the DCIR peaked and the CE started dropping, indicating lithium over-plating. In contrast, the battery cell with the polymer composite layer had a stable DCIR by cycle 30. The anode interface and CE indicated that the anode was not degraded and functioning properly.

### Additives

In some variations, the liquid electrolyte can include one or more additives. In various aspects, the additives can include N-methyl-N-propylpyrrolidinium bis(fluorosulfonyl)imide, lithium difluoro(oxalato)borate (LiDFOB), pro-1-ene-1,3-sultone (PES), methylene methanedisulfonate (MMDS), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), and/or 1,3,6-hexanetricarbonitrile (HTCN), in any combination, and in ranges of quantities. In some variations, the ionic liquid N-methyl-N-propylpyrrolidinium bis(fluorosulfonyl) imide is added. Each of the additives above can be individually chosen or selected from amongst the listed additives.

In some variations, LiDFOB is at least 0.1 wt % of the total liquid electrolyte. In some variations, LiDFOB is at least 0.2 wt % of the total liquid electrolyte. In some variations, LiDFOB is at least 0.3 wt % of the total liquid electrolyte. In some variations, LiDFOB is at least 0.4 wt % of the total liquid electrolyte. In some variations, LiDFOB is at least 0.5 wt % of the total liquid electrolyte. In some variations, LiDFOB is at least 0.6 wt % of the total liquid electrolyte. In some variations, LiDFOB is at least 0.7 wt % of the total liquid electrolyte. In some variations, LiDFOB is at least 0.8 wt % of the total liquid electrolyte. In some variations, LIDFOB is at least 0.9 wt % of the total liquid electrolyte. In some variations, LiDFOB is at least 1.0 wt % of the total liquid electrolyte. In some variations, LiDFOB is at least 1.3 wt % of the total liquid electrolyte. In some variations, LiDFOB is at least 1.6 wt % of the total liquid electrolyte. In some variations, LiDFOB is at least 1.9 wt % of the total liquid electrolyte.

In some variations, LiDFOB is less than or equal to 2.0 wt % of the total liquid electrolyte. In some variations, LiDFOB is less than or equal to 1.9 wt % of the total liquid electrolyte. In some variations, LiDFOB is less than or equal to 1.3 wt % of the total liquid electrolyte. In some variations, LiDFOB is less than or equal to 1.3 wt % of the total liquid electrolyte. In some variations, LiDFOB is less than or equal to 1.1 wt % of the total liquid electrolyte. In some variations, LiDFOB is less than or equal to 1.0 wt % of the total liquid electrolyte. In some variations, LiDFOB is less than or equal to 0.9 wt % of the total liquid electrolyte. In some variations, LiDFOB is less than or equal to 0.8 wt % of the total liquid electrolyte. In some variations, LiDFOB is less than or equal to 0.7 wt % of the total liquid electrolyte. In some variations, LiDFOB is less than or equal to 0.6 wt % of the total liquid electrolyte. In some variations, LiDFOB is less than or equal to 0.5 wt % of the total liquid electrolyte. In some variations, LiDFOB is less than or equal to 0.4 wt % of the total liquid electrolyte. In some variations, LiDFOB is less than or equal to 0.3 wt % of the total liquid electrolyte. In some variations, LiDFOB is less than or equal to 0.2 wt % of the total liquid electrolyte.

In some variations, the amount of PES is at least 0.5 wt % of the total liquid electrolyte. In some variations, the amount of PES is at least 0.6 wt % of the total liquid electrolyte. In some variations, the amount of PES is at least 0.9 wt % of the total liquid electrolyte. In some variations, the amount of PES is at least 1.3 wt % of the total liquid electrolyte. In some variations, the amount of PES is at least 1.6 wt % of the total liquid electrolyte. In some variations, the amount of PES is at least 1.9 wt % of the total liquid electrolyte. In some variations, the amount of PES is at least 2.2 wt % of the total liquid electrolyte. In some variations, the amount of PES is at least 2.5 wt % of the total liquid electrolyte. In some variations, the amount of PES is at least 2.8 wt % of the total liquid electrolyte. In some variations, the amount of PES is at least 3.1 wt % of the total liquid electrolyte.

In some variations, the amount of PES is less than or equal to 3.5 wt % of the total liquid electrolyte. In some variations, the amount of PES is less than or equal to 3.1 wt % of the total liquid electrolyte. In some variations, the amount of PES is less than or equal to 2.8 wt % of the total liquid electrolyte. In some variations, the amount of PES is less than or equal to 2.5 wt % of the total liquid electrolyte. In some variations, the amount of PES is less than or equal to 2.2 wt % of the total liquid electrolyte. In some variations, the amount of PES is less than or equal to 1.9 wt % of the total liquid electrolyte. In some variations, the amount of PES is less than or equal to 1.6 wt % of the total liquid electrolyte. In some variations, the amount of PES is less than or equal to 1.3 wt % of the total liquid electrolyte. In some variations, the amount of PES is less than or equal to 1.1 wt % of the total liquid electrolyte. In some variations, the amount of PES is less than or equal to 0.9 wt % of the total liquid electrolyte. In some variations, the amount of PES is less than or equal to 0.6 wt % of the total liquid electrolyte.

In some variations, the amount of MMDS is at least 0.1 wt % of the total liquid electrolyte. In some variations, the amount of MMDS is at least 0.2 wt % of the total liquid electrolyte. In some variations, the amount of MMDS is at least 0.3 wt % of the total liquid electrolyte. In some variations, the amount of MMDS is at least 0.4 wt % of the total liquid electrolyte. In some variations, the amount of MMDS is at least 0.5 wt % of the total liquid electrolyte. In some variations, the amount of MMDS is at least 0.6 wt % of the total liquid electrolyte. In some variations, the amount of MMDS is at least 0.7 wt % of the total liquid electrolyte. In some variations, the amount of MMDS is at least 0.8 wt % of the total liquid electrolyte. In some variations, the amount of MMDS is at least 0.9 wt % of the total liquid electrolyte. In some variations, the amount of MMDS is at least 1.0 wt % of the total liquid electrolyte. In some variations, the amount of MMDS is at least 1.1 wt % of the total liquid electrolyte. In some variations, the amount of MMDS is at least 1.2 wt % of the total liquid electrolyte. In some variations, the amount of MMDS is at least 1.3 wt % of the total liquid electrolyte. In some variations, the amount of MMDS is at least 1.4 wt % of the total liquid electrolyte.

In some variations, the amount of MMDS is less than or equal to 1.5 wt % of the total liquid electrolyte. In some variations, the amount of MMDS is less than or equal to 1.4 wt % of the total liquid electrolyte. In some variations, the amount of MMDS is less than or equal to 1.3 wt % of the total liquid electrolyte. In some variations, the amount of MMDS is less than or equal to 1.2 wt % of the total liquid electrolyte. In some variations, the amount of MMDS is less than or equal to 1.1 wt % of the total liquid electrolyte. In some variations, the amount of MMDS is less than or equal to 1.0 wt % of the total liquid electrolyte. In some variations, the amount of MMDS is less than or equal to 0.9 wt % of the total liquid electrolyte. In some variations, the amount of MMDS is less than or equal to 0.8 wt % of the total liquid electrolyte. In some variations, the amount of MMDS is less than or equal to 0.7 wt % of the total liquid electrolyte. In some variations, the amount of MMDS is less than or equal to 0.6 wt % of the total liquid electrolyte. In some variations, the amount of MMDS is less than or equal to 0.5 wt % of the total liquid electrolyte. In some variations, the amount of MMDS is less than or equal to 0.4 wt % of the total liquid electrolyte. In some variations, the amount of MMDS is less than or equal to 0.3 wt % of the total liquid electrolyte. In some variations, the amount of MMDS is less than or equal to 0.2 wt % of the total liquid electrolyte.

In some variations, the amount of VEC is at least 0.1 wt % of the total liquid electrolyte. In some variations, the amount of VEC is at least 0.2 wt % of the total liquid electrolyte. In some variations, the amount of VEC is at least 0.3 wt % of the total liquid electrolyte. In some variations, the amount of VEC is at least 0.4 wt % of the total liquid electrolyte. In some variations, the amount of VEC is at least 0.5 wt % of the total liquid electrolyte. In some variations, the amount of VEC is at least 0.6 wt % of the total liquid electrolyte. In some variations, the amount of VEC is at least 0.7 wt % of the total liquid electrolyte. In some variations, the amount of VEC is at least 0.8 wt % of the total liquid electrolyte. In some variations, the amount of VEC is at least 0.9 wt % of the total liquid electrolyte.

In some variations, the amount of VEC is less than or equal to 0.9 wt % of the total liquid electrolyte. In some variations, the amount of VEC is less than or equal to 0.8 wt % of the total liquid electrolyte. In some variations, the amount of VEC is less than or equal to 0.7 wt % of the total liquid electrolyte. In some variations, the amount of VEC is less than or equal to 0.6 wt % of the total liquid electrolyte. In some variations, the amount of VEC is less than or equal to 0.5 wt % of the total liquid electrolyte. In some variations, the amount of VEC is less than or equal to 0.4 wt % of the total liquid electrolyte. In some variations, the amount of VEC is less than or equal to 0.3 wt % of the total liquid electrolyte. In some variations, the amount of VEC is less than or equal to 0.2 wt % of the total liquid electrolyte.

In some variations, the amount of FEC is at least 2 wt % of the total liquid electrolyte. In some variations, the amount of FEC is at least 4 wt % of the total liquid electrolyte. In some variations, the amount of FEC is at least 6 wt % of the total liquid electrolyte. In some variations, the amount of FEC is at least 8 wt % of the total liquid electrolyte. In some variations, the amount of FEC is less than or equal to 10 wt % of the total liquid electrolyte. In some variations, the amount of FEC is less than or equal to 8 wt % of the total liquid electrolyte. In some variations, the amount of FEC is less than or equal to 6 wt % of the total liquid electrolyte. In some variations, the amount of FEC is less than or equal to 4 wt % of the total liquid electrolyte.

In some variations, the amount of PS is at least 0.5 wt % of the total liquid electrolyte. In some variations, the amount of PS is at least 1.0 wt % of the total liquid electrolyte. In some variations, the amount of PS is at least 1.5 wt % of the total liquid electrolyte. In some variations, the amount of PS is at least 2.0 wt % of the total liquid electrolyte. In some variations, the amount of PS is at least 2.5 wt % of the total liquid electrolyte. In some variations, the amount of PS is at least 3.0 wt % of the total liquid electrolyte. In some variations, the amount of PS is at least 3.5 wt % of the total liquid electrolyte. In some variations, the amount of PS is at least 4.0 wt % of the total liquid electrolyte. In some variations, the amount of PS is at least 4.5 wt % of the total liquid electrolyte. In some variations, the amount of PS is at least 5.0 wt % of the total liquid electrolyte.

In some variations, the amount of PS is less than or equal to 6.0 wt % of the total liquid electrolyte. In some variations, the amount of PS is less than or equal to 5.5 wt % of the total liquid electrolyte. In some variations, the amount of PS is less than or equal to 5.0 wt % of the total liquid electrolyte. In some variations, the amount of PS is less than or equal to 4.5 wt % of the total liquid electrolyte. In some variations, the amount of PS is less than or equal to 4.0 wt % of the total liquid electrolyte. In some variations, the amount of PS is less than or equal to 3.5 wt % of the total liquid electrolyte. In some variations, the amount of PS is less than or equal to 3.0 wt % of the total liquid electrolyte. In some variations, the amount of PS is less than or equal to 2.5 wt % of the total liquid electrolyte. In some variations, the amount of PS is less than or equal to 2.0 wt % of the total liquid electrolyte. In some variations, the amount of PS is less than or equal to 1.5 wt % of the total liquid electrolyte. In some variations, the amount of PS is less than or equal to 1.0 wt % of the total liquid electrolyte.

In some variations, the amount of SN is at least 0.5 wt % of the total liquid electrolyte. In some variations, the amount of SN is at least 1.0 wt % of the total liquid electrolyte. In some variations, the amount of SN is at least 1.5 wt % of the total liquid electrolyte. In some variations, the amount of SN is at least 2.0 wt % of the total liquid electrolyte. In some variations, the amount of SN is at least 2.5 wt % of the total liquid electrolyte. In some variations, the amount of SN is at least 3.0 wt % of the total liquid electrolyte. In some variations, the amount of SN is at least 3.5 wt % of the total liquid electrolyte. In some variations, the amount of SN is at least 4.0 wt % of the total liquid electrolyte. In some variations, the amount of SN is at least 4.5 wt % of the total liquid electrolyte. In some variations, the amount of SN is at least 5.0 wt % of the total liquid electrolyte.

In some variations, the amount of SN is less than or equal to 6.0 wt % of the total liquid electrolyte. In some variations, the amount of SN is less than or equal to 5.5 wt % of the total liquid electrolyte. In some variations, the amount of SN is less than or equal to 5.0 wt % of the total liquid electrolyte. In some variations, the amount of SN is less than or equal to 4.5 wt % of the total liquid electrolyte. In some variations, the amount of SN is less than or equal to 4.0 wt % of the total liquid electrolyte. In some variations, the amount of SN is less than or equal to 3.5 wt % of the total liquid electrolyte. In some variations, the amount of SN is less than or equal to 3.0 wt % of the total liquid electrolyte. In some variations, the amount of SN is less than or equal to 2.5 wt % of the total liquid electrolyte. In some variations, the amount of SN is less than or equal to 2.0 wt % of the total liquid electrolyte. In some variations, the amount of SN is less than or equal to 1.5 wt % of the total liquid electrolyte. In some variations, the amount of SN is less than or equal to 1.0 wt % of the total liquid electrolyte.

In some variations, the amount of HTCN is at least 0.01 wt % of the total liquid electrolyte. In some variations, the amount of HTCN is at least 0.1 wt % of the total liquid electrolyte. In some variations, the amount of HTCN is at least 0.5 wt % of the total liquid electrolyte. In some variations, the amount of HTCN is at least 1.0 wt % of the total liquid electrolyte. In some variations, the amount of HTCN is at least 1.5 wt % of the total liquid electrolyte. In some variations, the amount of HTCN is at least 2.0 wt % of the total liquid electrolyte. In some variations, the amount of HTCN is at least 2.5 wt % of the total liquid electrolyte. In some variations, the amount of HTCN is at least 3.0 wt % of the total liquid electrolyte. In some variations, the amount of HTCN is at least 3.5 wt % of the total liquid electrolyte. In some variations, the amount of HTCN is at least 4.0 wt % of the total liquid electrolyte. In some variations, the amount of HTCN is at least 4.5 wt % of the total liquid electrolyte. In some variations, the amount of HTCN is at least 5.0 wt % of the total liquid electrolyte. In some variations, the amount of HTCN is at least 5.5 wt % of the total liquid electrolyte.

In some variations, the amount of HTCN is less than or equal to 6.0 wt % of the total liquid electrolyte. In some variations, the amount of HTCN is less than or equal to 5.5 wt % of the total liquid electrolyte. In some variations, the amount of HTCN is less than or equal to 5.0 wt % of the total liquid electrolyte. In some variations, the amount of HTCN is less than or equal to 4.5 wt % of the total liquid electrolyte. In some variations, the amount of HTCN is less than or equal to 4.0 wt % of the total liquid electrolyte. In some variations, the amount of HTCN is less than or equal to 3.5 wt % of the total liquid electrolyte. In some variations, the amount of HTCN is less than or equal to 3.0 wt % of the total liquid electrolyte. In some variations, the amount of HTCN is less than or equal to 2.5 wt % of the total liquid electrolyte. In some variations, the amount of HTCN is less than or equal to 2.0 wt % of the total liquid electrolyte. In some variations, the amount of HTCN is less than or equal to 1.5 wt % of the total liquid electrolyte. In some variations, the amount of HTCN is less than or equal to 1.0 wt % of the total liquid electrolyte.

The electrolyte solvent may also have a salt dissolved therein. The salt may be any type of salt suitable for battery cells. For example, and without limitation, salts for a lithium-ion battery cell include LiPF₆, LiBF₄, LiClO₄, LiSO₃CF₃, LiN(SO₂CF₃)₂, LiBC₄O₈, Li[PF₃(C₂CF₅)₃], and LiC(SO₂C_{F3})₃. Other salts are possible, including combinations of salts.

The liquid electrolytes described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A battery cell comprising:
a cathode comprising a cathode active material disposed on a cathode current collector;
an anode comprising an anode active material disposed on an anode current collector, the anode oriented towards the cathode such that the anode active material faces the cathode active material;
a separator disposed between the cathode active material and the anode active material; and
the liquid electrolyte comprising bis(2,2,2-trifluoroethyl)carbonate (TFEC) diluent and bis(1,1-difluoroethoxy)ethane (BDOE) solvent, the liquid electrolyte disposed between the cathode and anode.

2. The battery cell of claim 1, wherein the ratio of wt % TFEC diluent to wt % BDOE solvent is 1:5.0-1:2.0.

3. The battery cell of claim 1, wherein the electrolyte fluid comprises a lithium salt selected from LiFSI, LiTFSI, LiBOB, LiPF₆, LiBF₄, LiClO₄, LiSO₃CF₃, LiN(SO₂F)₂, LiN(SO₂CF₃)₂, LiBC₄O₈, Li[PF₃(C₂CF₅)₃], LiC(SO₂CF₃)₃, and a combination thereof.

4. The battery cell of claim 3, wherein the lithium salt comprises LiFSI.

5. The battery cell of claim 3, wherein the lithium salt comprises LiFSI and LiBOB.

6. The battery cell of claim 3, wherein the lithium salt is in an amount of 15-50 mol % of the liquid electrolyte.

7. The battery cell of claim 6, wherein the lithium salt is in an amount of 20-40 mol % of the liquid electrolyte.

8. The battery cell of claim 1, wherein the electrolyte fluid comprises an additive selected from N-methyl-N-propylpyrrolidinium bis(fluorosulfonyl)imide, lithium difluoro(oxalato)borate (LiDFOB), pro-1-ene-1,3-sultone (PES), methylene methanedisulfonate (MMDS), propylene carbonate (PC), vinyl ethylene carbonate (VEC), propane sultone (PS), fluoroethylene carbonate (FEC), succinonitrile (SN), vinyl carbonate (VC), adiponitrile (ADN), ethyleneglycol bis(2-cyanoethyl)ether (EGPN), and a combination thereof.

9. The battery cell of claim 1, having an external operating pressure of 20 psi or less.

10. The battery cell of claim 1, comprising a polymer composite layer disposed between the anode and separator.

11. The battery cell of claim 10, wherein the polymer composite layer has a porosity of less than 10.0%.

12. The battery cell of claim 10, comprising an anode cap layer disposed between the anode and the polymer composite layer.

13. The battery cell of claim 12, wherein the anode cap layer is selected from Sn, Cu, and a combination thereof.

14. The battery cell of claim 10, wherein the polymer composite layer adheres the anode cap layer to the separator.

15. The battery cell of claim 10, wherein the polymer composite layer comprises a crosslinked polymer backbone, polyethylene glycol, polycaprolactone, and a lithium salt.

16. The battery cell of claim 15, wherein the crosslinked polymer backbone has an un-crosslinked molecular weight of between 100,000 g/mol and 2,000,000 g/mol and is selected from the group consisting of PVDF-HFP, PEGDMA, polyDDA, PVB, PUA, PEO, PAN, PMMA, and copolymers thereof.

17. The battery cell of claim 15, wherein the polyethylene glycol has a molecular weight between 20,000 g/mol and 200,000 g/mol and is between 1.0 wt % and 20.0 wt % of the polymer composite layer.

18. The battery cell of claim 15, wherein the polycaprolactone has a molecular weight between 20,000 g/mol and 200,000 g/mol and is between 1.0 wt % and 40.0 wt % of the polymer composite layer.

19. The battery cell of claim 15, wherein a ratio of the one or more lithium salt to a total of a cross linked polymer backbone, the polyethylene glycol, and the polycaprolactone is less than 0.4:1.0.

20. The battery cell of claim 15, wherein the crosslinked polymer backbone is PVDF-HFP.
